(19) United States
(12) Patent Application Publication
(10) Pub. No.: US 2020/0391604 A1
(43) Pub. Date: Dec. 17, 2020

(54) Energy Recycling System (ERS)

(71) Applicant: Ecolution kWh, LLC, Naples, FL (US)

(72) Inventors: Johanne Medina, Naples, FL (US); Johnny Then-Gautier, Naples, FL (US)

(21) Appl. No.: 16/876,010

(22) Filed: May 16, 2020

Related U.S. Application Data
(63) Continuation of application No. 16/726,862, filed on Dec. 25, 2019, now abandoned.
(60) Provisional application No. 62/784,904, filed on Dec. 26, 2018.

(51) Int. Cl. B60L 53/56; B60L 50/30; B62D 13/06

(52) U.S. Cl. CPC B60L 53/56; B60L 2200/28; B62D 13/06; B60L 50/30

(57) ABSTRACT

A trailer power system having energy generation systems for generating energy from rotation of the wheels and storage devices mounted on a trailer. The system may include switching devices for controlling flow of power there between and to electrically powered systems of the truck and/or the trailer. The energy that is stored in the storage devices may be utilized by or sold to the operator or the tractor. The storage devices may also be removable for other uses.

### CROSS-REFERENCE TO RELATED APPLICATIONS

This application is a Continuation of pending U.S. Non-Provisional patent application Ser. No. 16/726,862 titled “Energy Recycling System (ERS)”, filed on Dec. 25, 2019, which claims benefit to U.S. Provisional patent application Ser. No. 62/784,904 titled “Energy Recycling System (ERS)”, filed on Dec. 26, 2018, the disclosure of both which are herein incorporated by reference in their entirety.

### Patents Cited

The following documents and references are incorporated by reference in their entirety, Pierce et al (U.S. Pat. No. 9,321,352), Kang et al (U.S. Pat. No. 7,642,563), Healy et al (WO 2018/064622).

### FIELD OF THE INVENTION

The present invention relates to energy generation systems and, more particularly, to energy generation systems for trailer trucks that generate energy from the movement of the trailer for storing in batteries, supplying energy to the trailer vehicle during use and/or providing stored energy to other vehicles.

### DESCRIPTION OF THE RELATED ART

In today's economy, as a result of people living throughout a country, goods are transported across and around the country. As trains and ships are not able to get to the vast majority of the recipients or end users for the goods, trucks play an important role in transporting goods. In fact, in the United States today, trucks transport about 70% of the freight that is transported annually.

A large amount of those goods are transported by trailer trucks, whereby truck drivers will pick up goods loaded onto a trailer for delivery. Once delivered, the truck driver often unhitches the trailer thereby allowing him or her to pick up additional goods on another trailer. The truck driver may own or lease the truck, or may work as part of a fleet company (e.g., FedEx or Walmart).

With movements to protect the environment and to provide for more efficient and inexpensive travel, more and more trailer trucks are or will likely be converted into hybrid or purely electric vehicles. However, because of the large amount of weight that is often transported, current batteries for trailer trucks do not provide for an extensive range of travel before the batteries need to be recharged. Thus, a truck driver will need to continually stop to recharge the electric battery which can be time intensive and inconvenient depending on the location of the charging stations relative to the truck driver's preferred routes.

Therefore, there is a need to provide an efficient and economical method for generating energy while operating a trailer truck.

It is also an object of the present invention to provide for a way for the owner of the trailers to monetize the use of the energy generation systems.

Other objects of the invention will be apparent from the following detailed disclosure, taken in conjunction with the accompanying sheets of drawings, wherein like reference numerals refer to like parts.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

In one aspect the invention is about a method for supplying energy to a tractor comprising generating energy from the rotation of one or more of the trailer wheels, saving that energy into one or more batteries located on said trailer, providing energy from those batteries to the tractor pulling said trailer as required by said tractor and metering the amount of energy transmitted to said tractor. In another variation of the present invention, the energy may be stored in a series of batteries for use by the tractor or for removal and use by others.

Other features and advantages of the present invention will become apparent upon examining the following detailed description of an embodiment thereof, taken in conjunction with the attached drawings.

### BRIEF DESCRIPTION OF THE DRAWINGS

FIG. 1 is a front perspective view showing the components of a disc brake system, according to the prior art.

FIG. 2 is a perspective view of a coupled disc brake and generator, according to one embodiment of the invention.

FIG. 3 is a rear view of a coupled disc brake and generator, according to one embodiment of the invention.

FIGS. 4-5 are perspective views of tractor with a trailer showing their respective undercarriages or bogies and one embodiment of the energy recycling system mounted on the trailer.

FIG. 6 is a perspective view of a trailer utilizing the energy recycling system of the present invention.

FIG. 7 is a partial perspective view of the trailer of FIG. 6 illustrating the components of one embodiment of the energy recycling system of the present invention utilized with a pair of axles.

FIG. 8 is a partial perspective view of the trailer of FIG. 6 illustrating one embodiment of the energy storage system of the present invention.

FIG. 9 is a partial perspective view illustrating components of the energy recycling system in connection with one pair of tires of an axle of the trailer of FIG. 6.

FIGS. 10-13 are perspective views illustrating embodiments of an energy generation system of the energy recycling system of the present invention.

FIG. 14 is a perspective view of one embodiment of a pair of energy control units of the present invention.

FIG. 15 is a partial perspective view of one embodiment of components of the energy recycling system of the present invention.

The above-described and other features will be appreciated and understood by those skilled in the art from the following detailed description, drawings, and appended claims.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

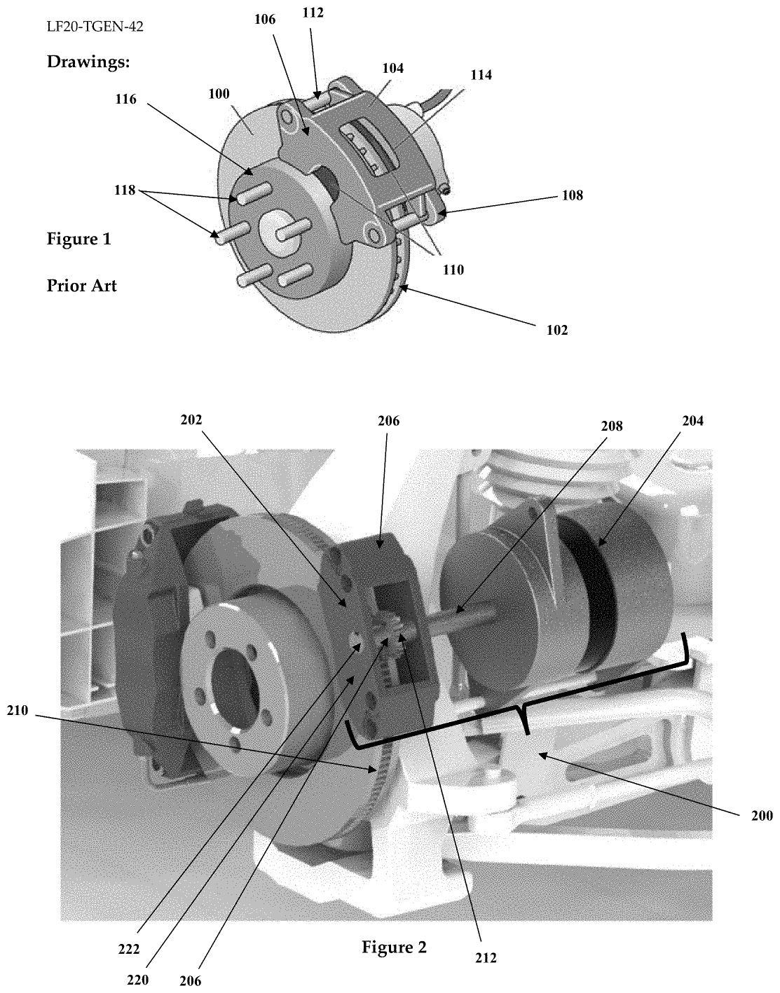

Referring to FIG. 1, a disc brake system as presently embodied in the prior art is shown with a disc or disk brake rotor 100 that has ventilating slots 102 circumferentially positioned about the center of the disc or disk brake rotor 100. A brake caliper 104 having a hollow interior defined by a pair of side portions 106, 108 is positioned astride of the disc brake rotor 100. Positioned within the hollow interior on the inside of the side portions 106, 108 are a pair of brake pads 110 sized to engage a portion of the outer surfaces of the disc brake rotor 100. A guide pin 112 located at one end of the brake caliper 104 allows the brake caliper 104 to be squeezed, thereby moving the brake pads 110 into engagement with the disc brake rotor 100. An inspection hole 114 on the top of the brake caliper 104 allows for the brake pads 110 to be viewed to determine their relative wear. The disc brake rotor 110 is connected to the wheels through the wheel hub 116 and wheel studs 118. While a disc brake rotor is shown and disclosed, it is appreciated that the energy generation system of the present invention may be used with other components that rotate with the tires including, but not limited to, drum brakes.

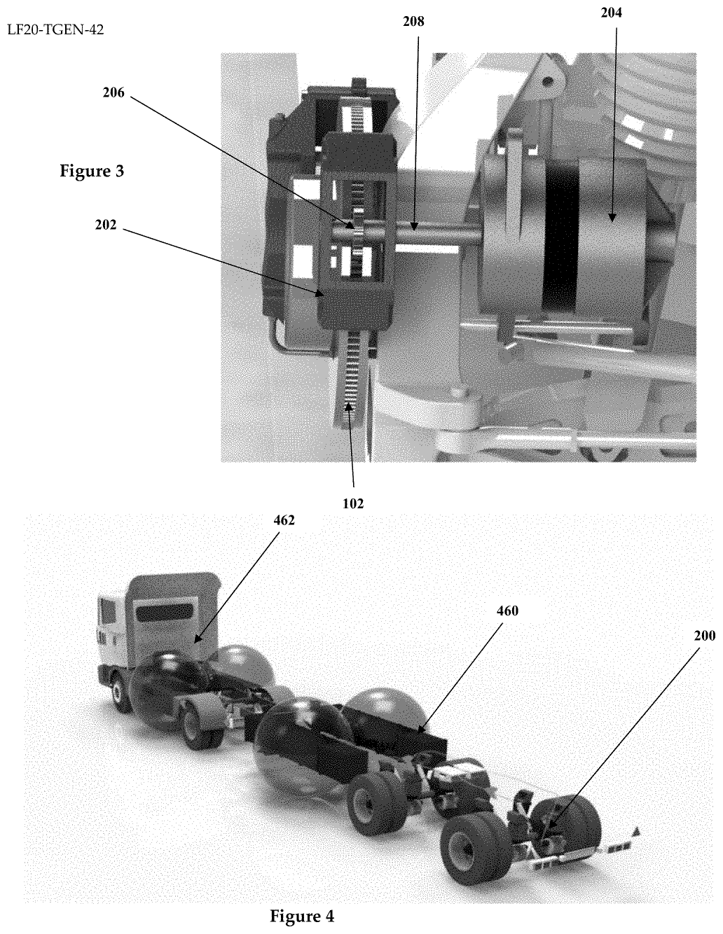

Referring to FIGS. 2-3, one embodiment of an energy generation system 200 for use with the energy recycling system of the present invention is shown as having a generator 204, a mechanical coupler 206 and a connecting member 208.

The mechanical coupler 206 is shown as a sprocket or gear having a plurality of teeth 212 spaced apart its circumference and sized and shaped to engage the corresponding ventilating slots 102 on the disc brake rotor 100. The mechanical coupler 206 is connected to a shaft or axle 208 through its center. In order to maintain the coupler 206 in position relative to the disc brake rotor 100, a bracket 202 may be used. Similar to the disc caliper 104 in operation, the bracket 202 remains parallel to the disc brake surface. In order to not interfere with the operation of the disc brake, the coupler 206 and bracket 202 are placed apart from the caliper 104 about the disc brake rotor 102.

Referring again to FIG. 2, the bracket 202, having a hollow interior defined by pair of side walls 220, is positioned astride of the disc brake rotor 100. Opposing holes 222 extend through the side walls 220 for receiving a portion of the axle or shaft 208 therethrough to allow the coupler 206 to be aligned with the ventilating slots 102.

The axle 208 is connected to the generator 204 for generating energy in the form of either alternating current (“AC”) or direct current (“DC”). The energy is then transmitted and/or stored in an energy storage component or system 452 that may be locally positioned in the trailer 460 or tractor 462 as set forth in more detail below.

In operation, one or more teeth 212 from the sprocket 206 engage respective slots in the ventilating slots 102 of the disc brake rotor 100. As the disc brake rotor 100 is rotated, the sprocket 206 and axle 208 will also rotate as the teeth 212 of the sprocket 206 are moved out of and into engagement with the slots 102. Thus, as the wheel moves, the disc brake rotor 100 moves, and the axle 208 going to the generator moves thereby creating energy to be stored in the vehicle.

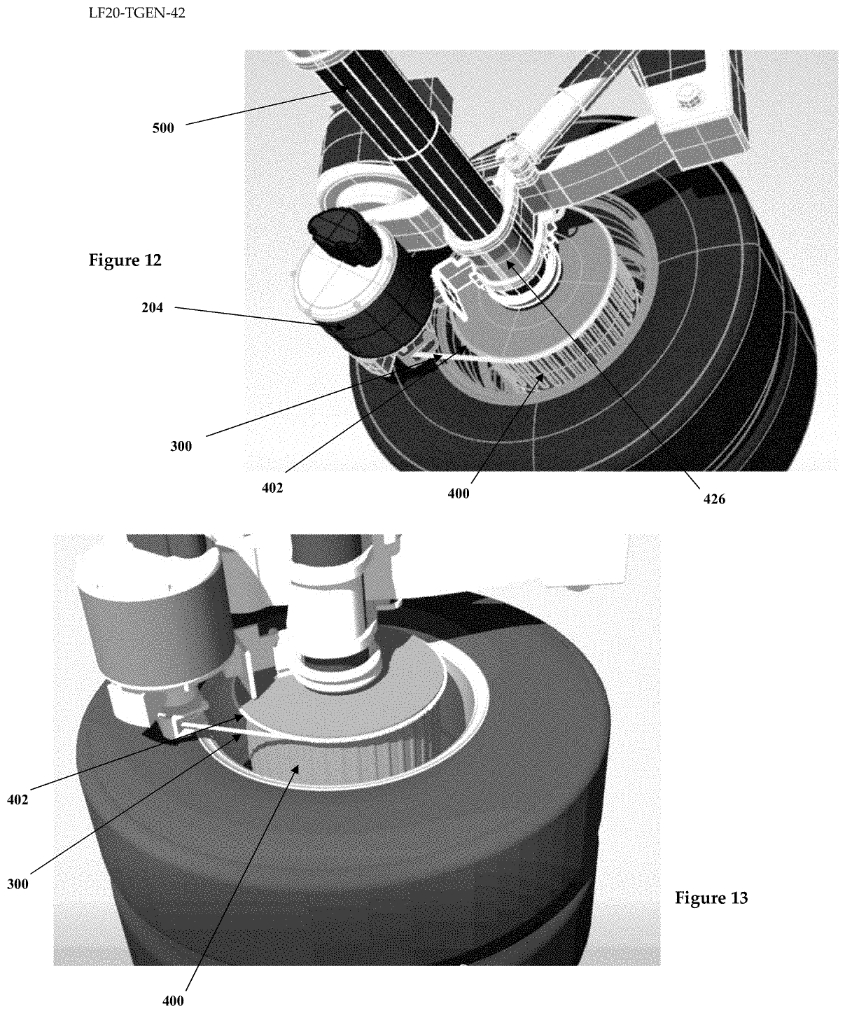

FIGS. 7-13 show another embodiment of the present invention utilizing a chain 300 to transmit rotational energy from a drum 400 of a drum brake to the coupler or sprocket 206. In this embodiment, the sprocket 206 is offset from the drum 400 and the chain 300 extends around and engages the lip 402 of the drum 400 and the teeth 212 of the sprocket 206 so that rotation of the drum 400 rotates the sprocket 206. It is appreciated that a belt may be used in place of the chain 300, and that either may be placed around a disc brake rotor 100 as well as the drum 400.

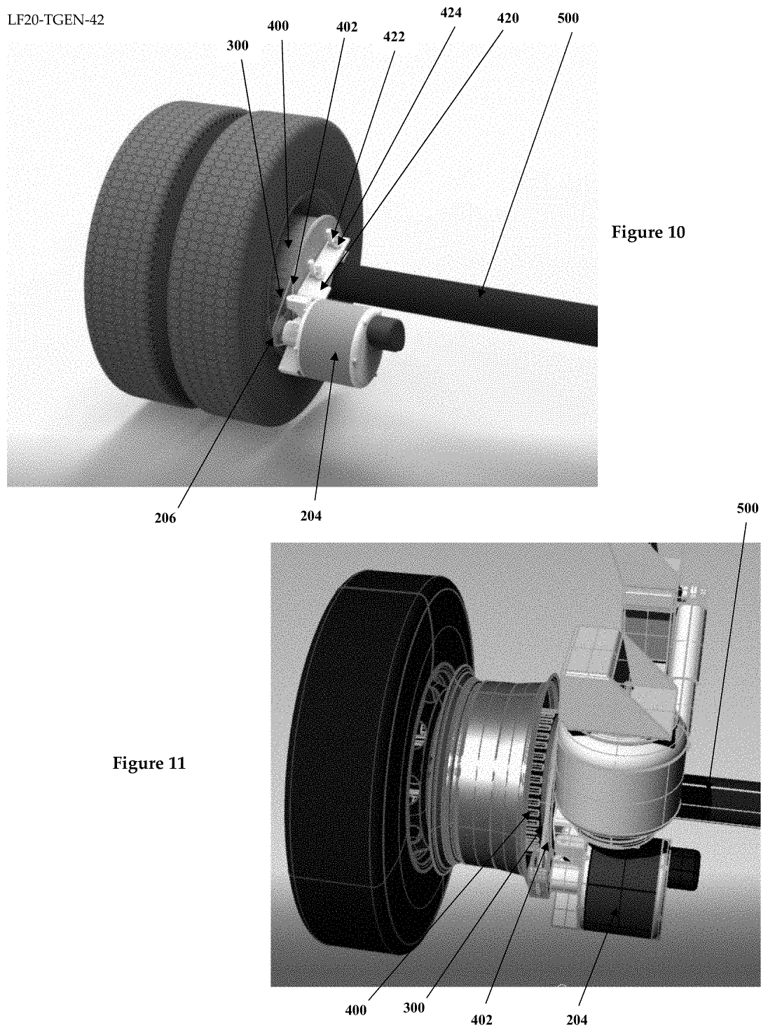

Referring to FIGS. 10-13, the generator 204 may be secured relative to an axle 500 for the trailer or vehicle by a bracket 420 that includes a pair of bolts 422 and nuts 424. The bracket 420 includes a central member 426 that defines a cylindrical opening for rotationally receiving the axle 500 therethrough.

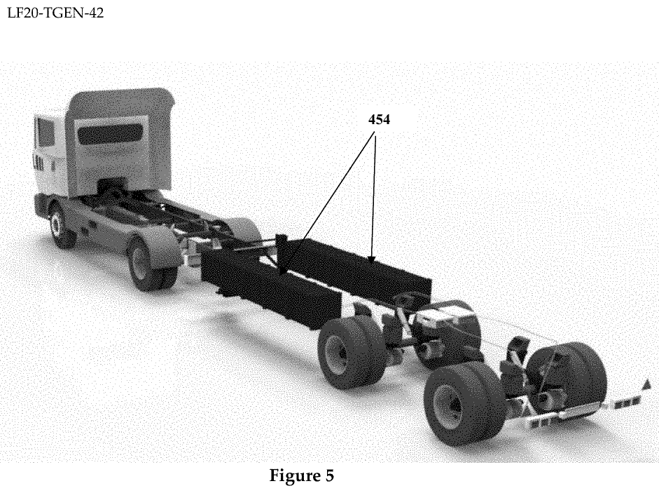

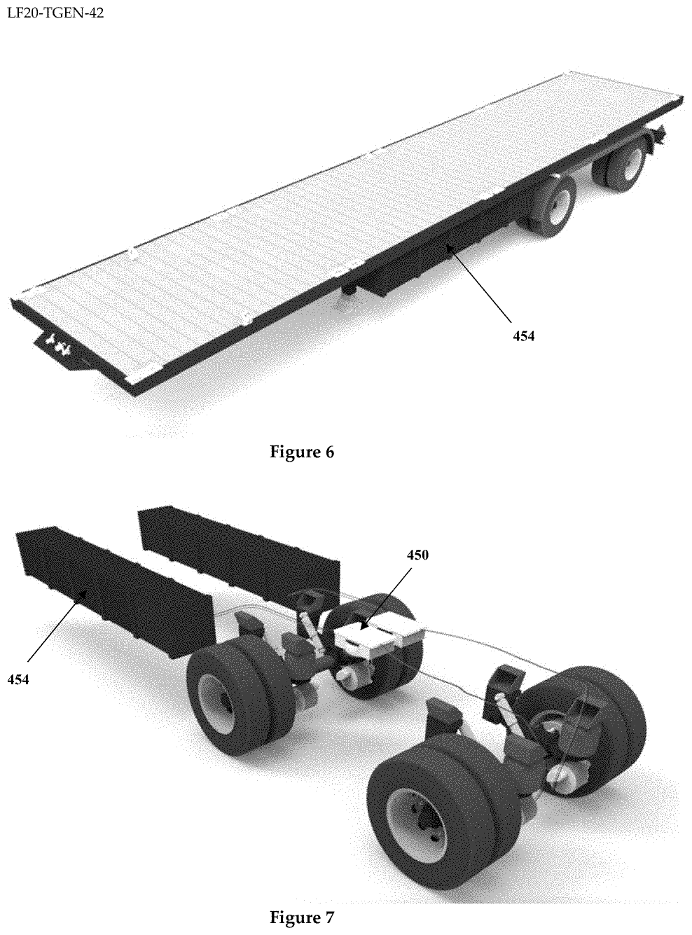

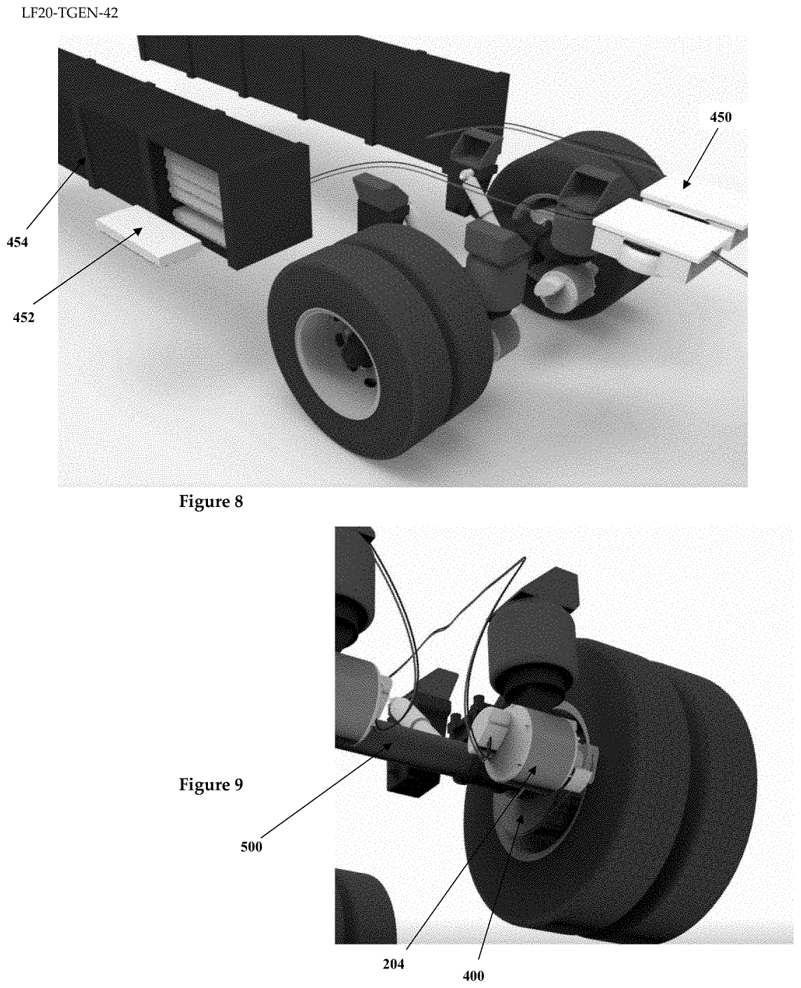

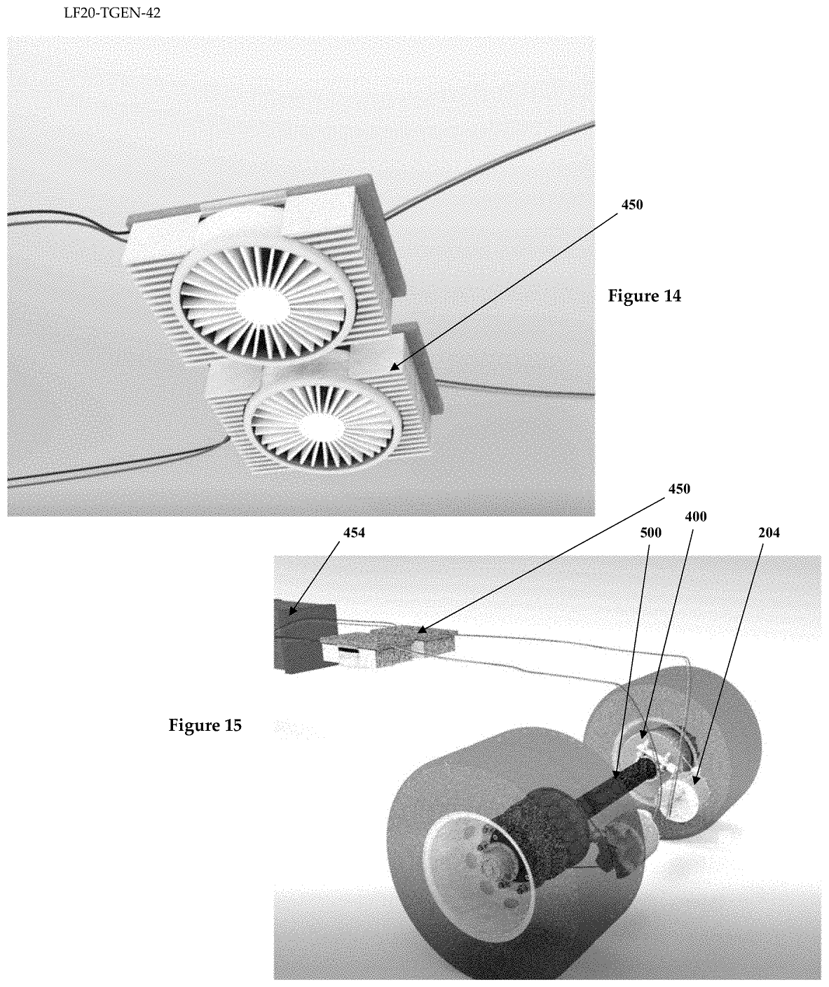

Referring again to FIGS. 4-15, energy generated by the energy generation system 200 may be sent to one ore more energy control units 450 that then transmit the energy to a plurality of batteries 452 located within compartments 454 of the trailer and/or tractor. The energy created and stored in the batteries 452 may then be used by the tractor or, as shown in FIG. 8, the batteries 452 may be removed to utilize and, if desired, sell the stored energy elsewhere. While the method of generating, storing, and selling energy is disclosed relative to trucks, it is appreciated that it may apply to other vehicles such as a moving train. The system may also include switching devices for controlling flow of power between the energy generation system and the storage batteries and to electrically powered systems of the truck and/or the trailer

It is appreciated that the ratio between the size of the sprocket 206 and the disc brake 100, drum 400 or other rotational component connected to the wheels may vary to increase or optimize energy generation. As an example, one ratio between the diameter of the disc brake rotor 100 or drum 400 for which the chain 300 is wrapped around to the sprocket or coupler 206 is 1:9, wherein when the disc brake rotor 100 or drum rotates once, the sprocket 206 and shaft 208 attached thereto will rotate nine times. This ratio may be employed to increase energy generation for vehicles that travel at a higher speed (e.g., between 35 mph and 70 mph). It is appreciated other ratios will have different ideal ratios, defined by the variables including the type of generator used and the average speed of the vehicle.

A software application may be utilized to track the amount of energy bring produced and stored through the energy recycling system. The amount of energy that is consumed from the tractor from the generated energy may also be tracked to monitor and charge for its usage if desired. A telemetric device may be used to remotely transmit the information collected about the stored and used energy.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A method for utilizing energy generated by driving of a truck tractor comprising the steps of:
connecting the tractor to a trailer having wheels and one or more energy generation systems operationally connected to one or more of the wheels to generate energy from the rotation of the one or more of the wheels;
storing the energy generated by the one or more energy generation systems in one or more batteries;
providing the stored energy for use by an electric vehicle; and
determining the amount of stored energy used by the electric vehicle.

2. The method of claim 1 wherein the electric vehicle is the truck tractor.

3. The method of claim 2 which further comprises the step of charging a fee based on the amount of stored energy used by the truck tractor.

4. The method of claim 1 which further comprises the step of charging a fee based on the amount of stored energy used by the electric vehicle.

5. The method of claim 1 wherein the one or more batteries are a plurality of removable batteries.

6. The method of claim 5 wherein the plurality of removable batteries are stored in one or more compartments on the trailer.

7. The method of claim 5 which further comprises the steps of removing at least one or more of the removable batteries and providing the at least one or more of the removable batteries for use with the electric vehicle.

8. The method of claim 1 which further comprises the step of transmitting the information on the amount of energy stored and used to a remote location.

9. A method for utilizing energy generated by driving of a truck tractor comprising the steps of:
connecting the tractor to a trailer having wheels and one or more energy generation systems operationally connected to one or more of the wheels to generate energy from the rotation of the one or more of the wheels;
storing the energy generated by the one or more energy generation systems in one or more batteries;
providing the stored energy for use by an electric vehicle;
determining the amount of stored energy used by the electric vehicle;
transmitting the information on the amount of energy stored and used to a remote location; and
charging a fee based on the amount of stored energy used by the truck tractor.

10. The method of claim 9 wherein the electric vehicle is the truck tractor.

11. The method of claim 9 wherein the one or more batteries are a plurality of removable batteries.

12. The method of claim 11 wherein the plurality of removable batteries are stored in one or more compartments on the trailer.

13. The method of claim 11 which further comprises the steps of removing at least one or more of the removable batteries and providing the at least one or more of the removable batteries for use with the electric vehicle.
